(19) United States
(12) Patent Application Publication
(10) Pub. No.: US 2023/0401575 A1
(43) Pub. Date: Dec. 14, 2023

(54) SYSTEM AND METHOD FOR FACILITATING BLOCKCHAIN BASED BUSINESS TRANSITIONS

(71) Applicant: MUHAMMAD ADNAN SAEED, Odessa, FL (US)

(72) Inventor: MUHAMMAD ADNAN SAEED, Odessa, FL (US)

(21) Appl. No.: 17/837,183

(22) Filed: Jun. 10, 2022

(51) Int. Cl. G06Q 20/38; G06Q 20/40; G06Q 20/10

(52) U.S. Cl. CPC G06Q 20/389; G06Q 20/102; G06Q 20/401

(57) ABSTRACT

Provided is a system and method to facilitate blockchain-based business transactions between a community of users. The system comprises a novel platform that allows individual users to create scenario-based business transactions building blocks on the Internet and/or blockchain. Such user-created scenarios can be linked. The system generates and executes contracts based on linked scenarios that facilitate a seamless transaction of goods or services between two or more parties. Information relating to scenarios and contracts can be immutably stored on the blockchain and accessed by users. System users have access to community and personal dashboards configured to allow the users to manage their wallets, scenarios, contracts, transactions, notifications, and general settings.

### COPYRIGHT NOTICE

A portion of the disclosure of this patent document contains material that is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of Invention

This invention relates to creating everyday human transactions with the help of computer systems and blockchain networks. More particularly, the present invention relates to the process of creating scenario-based business transactions building blocks on the Internet and/or blockchain for the people who are creating any type of value in society, thus making it easier to incorporate them into other scenarios in order to create vertical or horizontal scaling of new businesses in addition to keeping ownership of values being created by people thus benefiting original owners of the values.

### Description of the Related Art

Traditionally, creating your own business has been anything but a painless experience as not everyone has the opportunity to engage in or own the value they create. In part, this is due to there being so many unnecessary steps and hoops in place that prevent people from creating sustainable and fulfilling ecosystems of business communities. If computers could learn to think more like us—it would mean less strain is placed on our resources and humanity can deal with other important things more effectively.

The power of collective intelligence in business is extremely powerful and profitable! Through the use of diversified communities that will create collaborative business networks, we can learn and experience the various ways in which we can generate and sustain economies in a way that is truly rewarding to everyone involved. This idea takes community engagement to a whole new level and has the potential to positively affect the way we view our workforce and economic development. Mutual rewards are the key when it comes to creating appreciative or reward-worthy interactions between people by helping drive exponential economic growth.

Blockchain technology that increases trust, security, transparency, and the traceability of data shared across a business network is evolving and new efficiencies can result in cost savings. Blockchain is sometimes called a “trustless” network—not because business partners don't trust each other, but because they don't have to. This trust is built on blockchain's enhanced security, greater transparency, and instant traceability. Beyond matters of trust, blockchain delivers even more business benefits, including the cost savings from increased speed, efficiency, and automation. By greatly reducing paperwork and errors, blockchain significantly reduces overhead and transaction-related costs and reduces or eliminates the need for third parties or middlemen to verify transactions.

In addition, blockchain smart contracts typically are used to automate the execution of an agreement so that all participants can be immediately certain of the outcome, without an intermediary's involvement. Such smart contracts can also be used to automate workflow by triggering the next action when certain conditions are met or used to immutably store data values.

Within alternate ecosystems, everyday human transactions such as, but not limited to,

manufacturing car batteries for electric vehicles or a person designing brochures requires a great amount of paperwork and effort occur. The proposed system leverages blockchain technology to provide an environment that allows for a more robust blockchain ecosystem while taking advantage of creating scenario-based business transactions building blocks on the Internet and/or blockchain for people that create value in society. Herein, the terms “scenario” or “scenarios” refer to potential or realized services or products provided by users. With the proposed system, such people are more readily incorporated into other scenarios in order to create vertical or horizontal scaling of new businesses. Furthermore, using such a system promotes self-ownership of the value generated by individuals. Included in the system is an easy-to-use GUI that will allow individuals to readily interact and participate with the system.

No previous inventions, patents, or other prior art, individually or in combination, appears to describe the invention proposed herein. Accordingly, the invention proposed herein seeks to overcome and resolve the existing technical difficulties currently plaguing the field and to overcome the aforementioned shortcomings of the prior art.

### BRIEF SUMMARY OF THE INVENTION

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The present invention's primary purpose is to provide a novel and improved method for securely designed applications that ensure the security and authenticity of original work in a commercial environment that leverages blockchain technology.

Another primary purpose of the invention is to provide a smart methodology directed to devices, systems, and methods for facilitating a new kind of ecosystem involving collections of businesses that facilitate the creation and growth of business communities. A computer applications conglomerate of businesses creates a collective cluster of self-sustainable business communities that can scale vertically or horizontally.

Another further objective of the present invention is to provide a smart methodology that includes one main scenario owner involving other scenario owners and purchasing the other scenario owners' scenarios, forming a contract and secured transaction among each other as a result.

Another further objective of the present invention is to provide a system for facilitating safe, secure, and cost-effective networking transactions among different members of a community.

Another further objective of the present invention is to provide an advanced system that allows for a secure exchange of gains or payments for the scenarios being created or transacted through the blockchain ledger records of users.

Another further objective of the present invention is to provide an advanced system where the minting of transactions will be verified on the proof-of-stake blockchain. Entrepreneurs, freelancers, teachers, and even professionals will have an opportunity to transact collectively for any type of scenario of a well-rounded portfolio of values (services/products) that they offer their customers/patrons with the help of verifiable blockchain blocks on the computer nodes.

Other aspects, advantages, and novel features of the present invention will become apparent from the detailed description of the invention when considered in conjunction with the accompanying drawings.

This Summary is provided merely for the purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following detailed description, figures, and claims.

### BRIEF DESCRIPTION OF DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a system diagram of the contracts echo system, in accordance with an

embodiment of the invention.

FIG. 2 is a block diagram illustrating the different components inside the contracts echo

system, in accordance with an embodiment of the invention.

FIG. 3 is an illustration of the horizontal scenario scaling of the contracts echo system, in

accordance with an embodiment of the invention.

FIG. 4 is an illustration of the vertical scenario scaling of the contracts echo system, in

accordance with an embodiment of the invention.

FIG. 5 is a flowchart of an exemplary store and modules for the app, in accordance with

one embodiment of the invention.

FIG. 6 is a flowchart of the app functionality, in accordance with one embodiment of the

invention.

FIG. 7 is an exemplary use case with horizontal scaling (edit scenario) in the contracts

echo system.

FIG. 8 is an exemplary use case with vertical scaling (edit scenario) in the contracts echo system.

FIG. 9 is an exemplary scenario of funds transfer flow in contracts echo system.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure, or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

According to an aspect of the invention, a computer-implemented method of managing an information network is provided by an interface between a social network and a content network. The method includes creating a community of users; where each user is adding value to the system and will be rewarded for their original piece of work. It has been observed that the lack of accountability, transparency, and security in business practices has plagued humanity since the beginning of time. Blockchain technology represents the first opportunity for verifiable, non-custodial, immutable data records. With this concept, we utilize the blockchain as both an original data storage platform and the version tracking system for transactions-related data. Each epoch (block) represents an earlier version of the immutable records, enabling anyone to backtrack each epoch's history for verification purposes.

The technology as per its additional embodiments also proposes an electronic device for the implementation of the system including: a processor; a memory for storing machine-executable instructions; wherein, by reading and executing machine-executable instructions stored by the memory corresponding to control logic based on authentication of a blockchain across blockchains. In some embodiments, the processing device is configured to execute computer-readable program code further to manage immutable records stored over blockchain nodes.

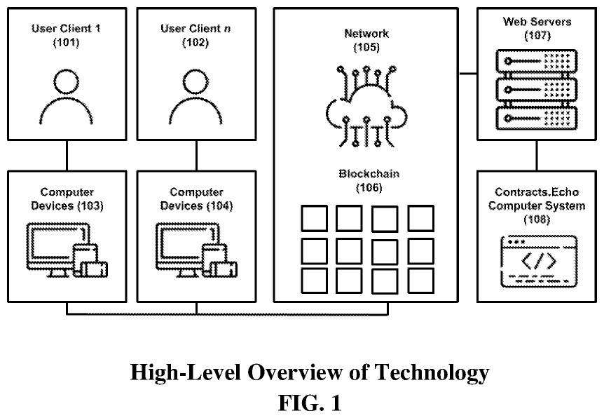

Referring now to FIG. 1, there is shown the system architecture adapted to support one embodiment of the present invention. FIG. 1 and the other figures use reference numerals to identify like elements. For example, “108” refers to the specific elements in the figures bearing that reference numeral.

The network 105 represents the communication pathways between the user clients and the contracts echo system 108. In one embodiment, the network is the Internet. The network can also utilize dedicated or private communication links (e.g., WAN, MAN, or LAN) that are not necessarily part of the Internet. The network uses standard communications technologies and/or protocols.

The web server 107 presents webpages or other web content, which form the basic interface to the clients 101, 102. The clients use respective client devices 103, 104 to access one or more web pages, and provide data to the contracts echo system 108. In the context of this application, “data” is understood to include information about communities, scenarios, transactions, members, and the like.

In one embodiment, the client devices 101 102 are used by the client users for interacting with the contracts echo system 108. A client device can be any device that is or incorporates a computer such as a personal computer (PC), a desktop computer, a laptop computer, a notebook, a smartphone, or the like. A computer is a device having one or more general or special purpose processors, memory, storage, and networking components (either wired or wireless). The device executes an operating system, for example, a Microsoft Windows-compatible operating system (OS), Apple OS X or iOS, a Linux distribution, or Google's Android OS. In some embodiments, the client device 103, 104 may use a web browser, such as Microsoft Internet Explorer, Mozilla Firefox, Google Chrome, Apple Safari and/or Opera, as an interface to interact with the system 108.

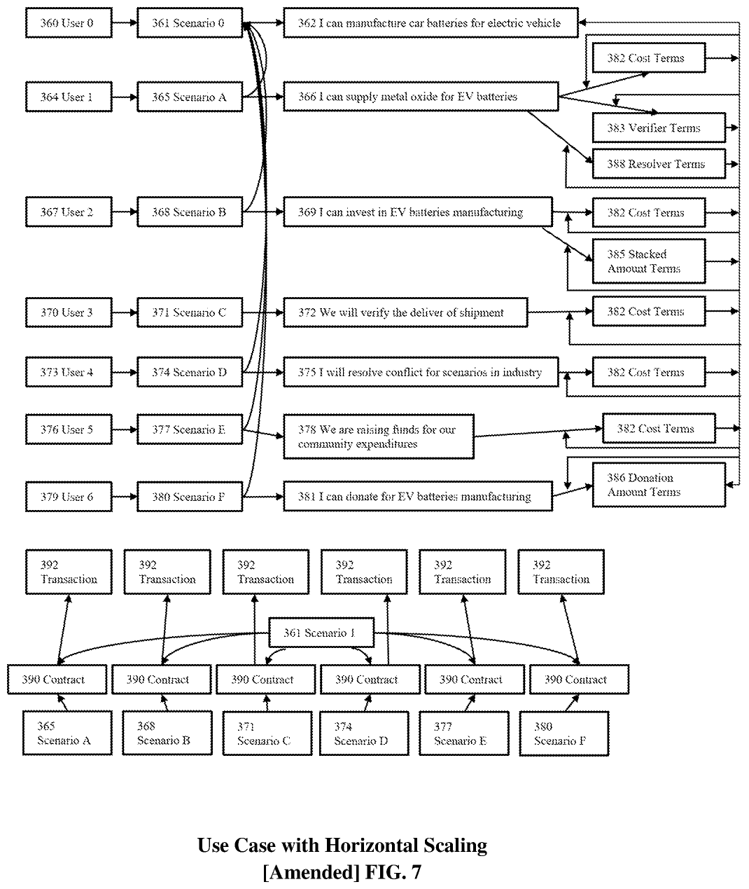

The system will be further explained now with an example. By looking at one side of the spectrum as shown in FIG. 7 the Illustration of applications's transaction; suppose a user 0 wants to manufacture car batteries for an electric vehicle (“EV”) and wants to get help from other users horizontally by attaching their scenarios such as user 1 can supply metal oxide for EV batteries, user 2 can donate for EV batteries manufacturing, user 3 can invest in EV batteries manufacturing, user 4 will verify the delivery of the shipment, user 5 will resolve conflict for scenarios in manufacturing industry, user 6 is raising funds for our community expenditures. Now by looking at FIG. 6 app's functionally each user will go through various each step in the process 309 create scenario, 310 choose description, 311 add tags, 312 customize scenario, 313 generate scenario, 314 edit scenario, 315 convert to contracts, 316 start workflow, 317 closing where's as the workflow would have 8 different sub steps; step 1 344 review, step 2 contract lock, step 3 verification, step 4 exchange, step 5 conflict resolution, step 6 transactions, step 7 transaction on chain and step 8 closing.

Once any transaction that includes information in blocks executes or completes from any

scenarios it is stored on the Internet and/or blockchain so that every transaction is verifiable.

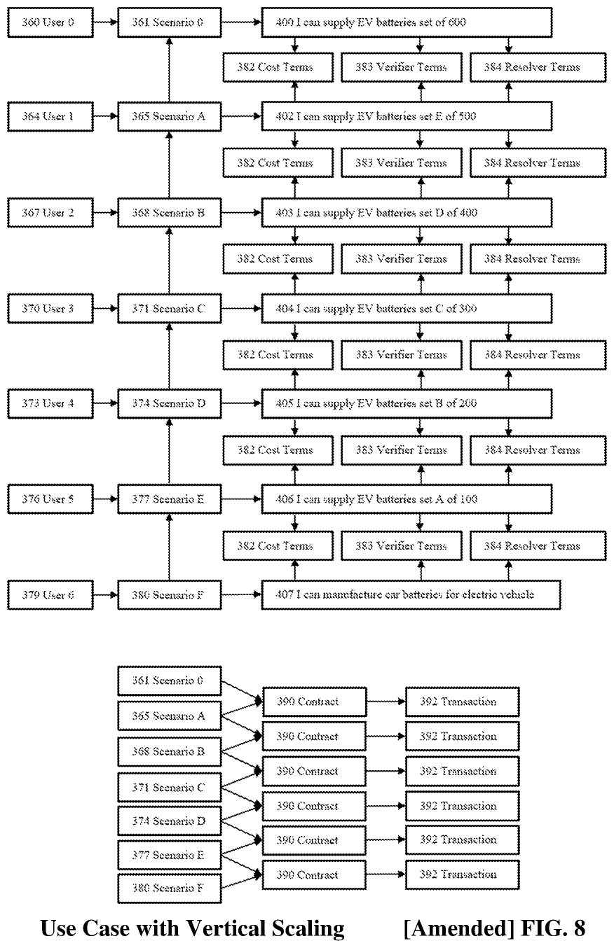

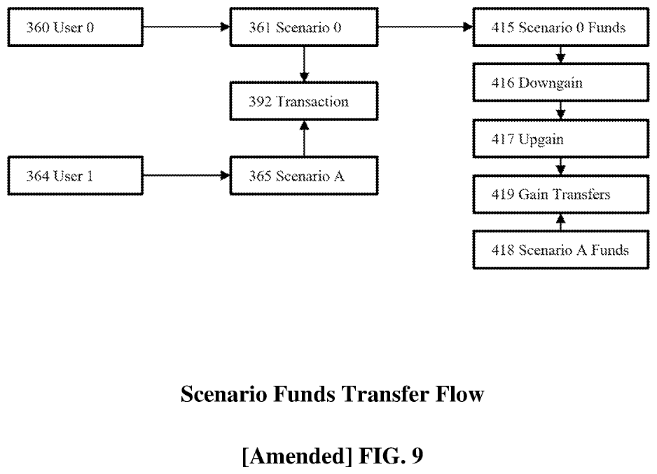

Let's now by referring FIG. 8 use case example in which each user attach only one other scenario and set terms such as 407 user 6 can manufacture car batteries, 406 user 5 can supply EV batteries set A of 100, 407 user 4 can supply EV batteries set B of 200, 408 user 3 can supply EV batteries set C of 300, 408 user 2 can supply EV batteries set D of 400, 408 user 1 can supply EV batteries set D of 500, 409 user 0 can supply EV batteries set E of 600. Now by looking at FIG. 6 app's functionally each user will go through various each step in the process 309 create scenario, 310 choose description, 311 add tags, 312 customize scenario, 313 generate scenario, 314 edit scenario, 315 convert to contracts, 316 start workflow, 317 closing where's as the workflow would have 8 different sub steps; step 1 344 review, step 2 contract lock, step 3 verification, step 4 exchange, step 5 conflict resolution, step 6 transactions, step 7 transaction on chain, and step 8 closing.

All the users of the system as per its further embodiments have the ability to test any type of scenario before completing a transaction on the blockchain. In addition, anyone can search for existing profiles, scenarios, transactions, and ownerships via GUI.

All the users of the system as per its further embodiments can execute any use cases in their communities before they complete any transaction on the blockchain. Besides, it is possible to search for existing members, scenarios, and transactions.

In summary, the contracts echo system 108 allows people or users to transact collectively for any type of scenario and search communities, scenarios, transactions, and members. The contract's echo system 108 comprises additional components and modules that are described below.

### Contracts Echo Computer System

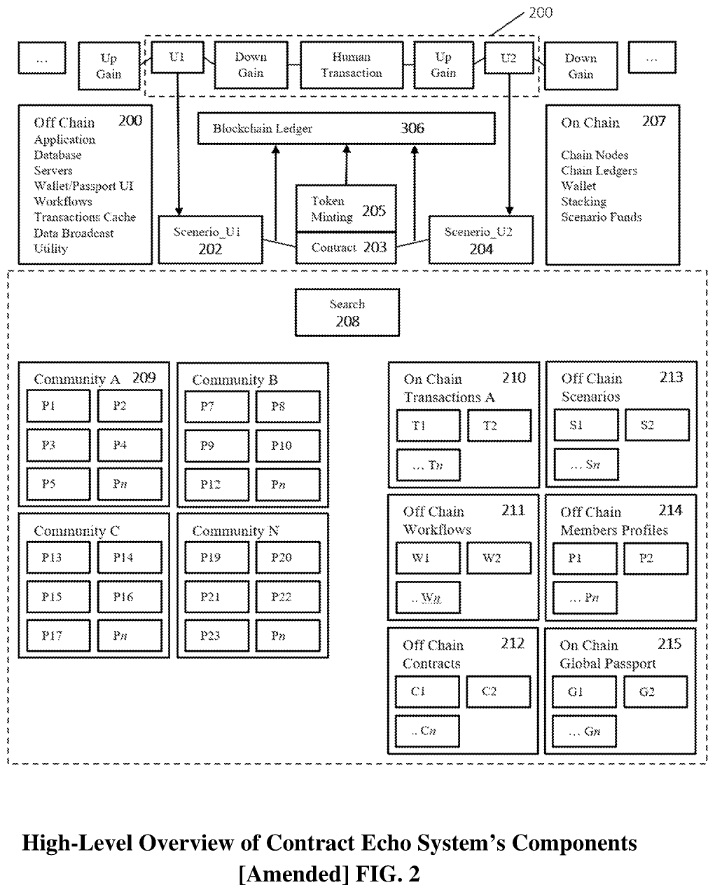

Referring to FIG. 1 and FIG. 2, in one embodiment the contracts echo system 108 comprises components: one marked as 201 may include off chain infrastructure the app, database, server nodes, wallet user interface, workflows, transactions cache, data broadcast utility; second marked as 207 may include on chain infrastructure the blockchain nodes, chain ledger with information such as transactions, wallet and/or stacking records, scenario funds and a like; third marked as 209 are representation of communities in the system; fourth marked as 208 is representation of search module for searching data information such as (e.g. communities store 241, a members store 242, a transactions store 243, etc.); fifth marked as 210 is representation of on chain transactions; sixth marked as 211 is representation of off chain workflow; seventh marked as 212 is representations of off-chain contracts; eight marked as 213 is representations of off-chain scenarios; ninth marked as 214 is representations of off-chain members; tenth marked as 215 is representations of off-chain passport of wallet user interface; eleventh marked as 200 is illustration of human transaction elements including user 1 as U1, user 2 as U2 and down again and up gain between two users; twelve marked as 306 is data store on blockchain ledger; thirteen marked as 205 is a process called minting transaction on blockchain; fourteen marked as 202 and 204 are scenarios whereas 203 is represent the contract or in simple words a terms set by both users for their scenarios.

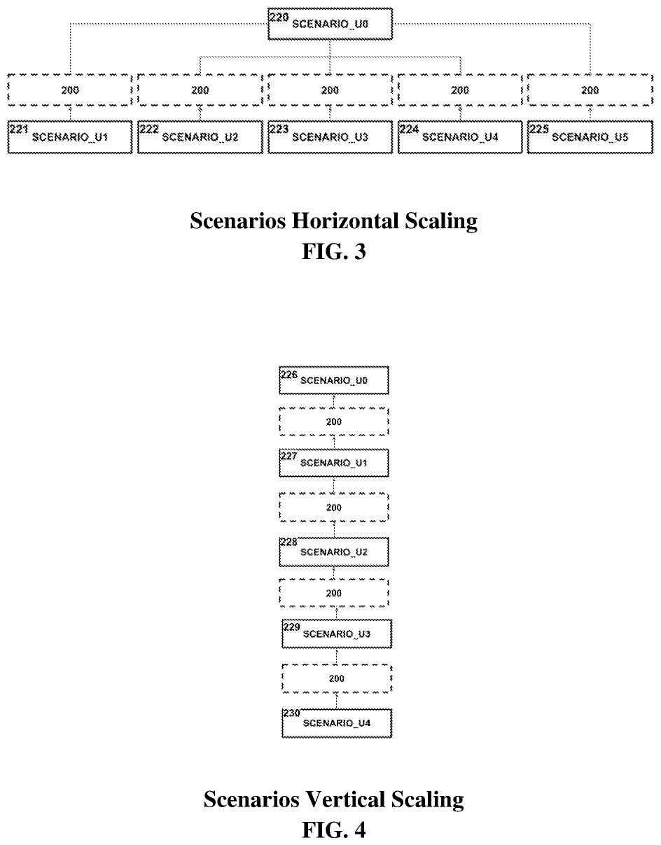

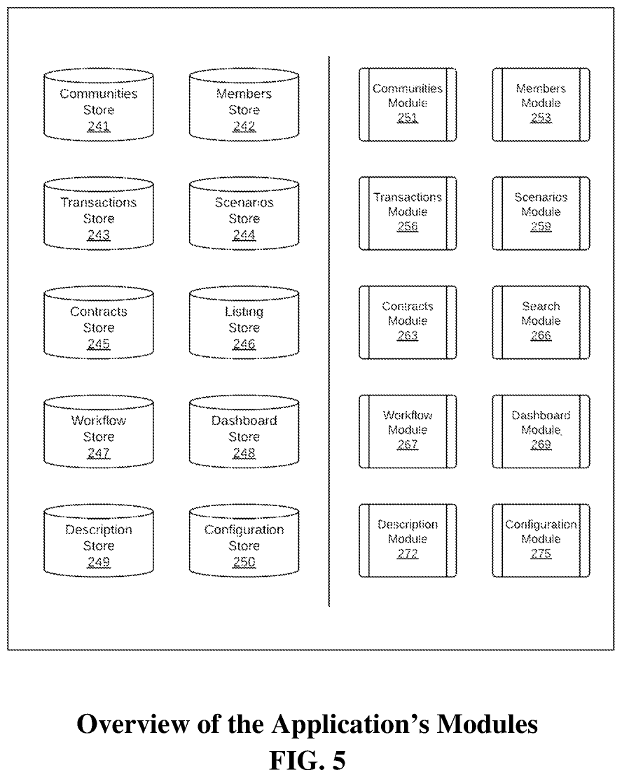

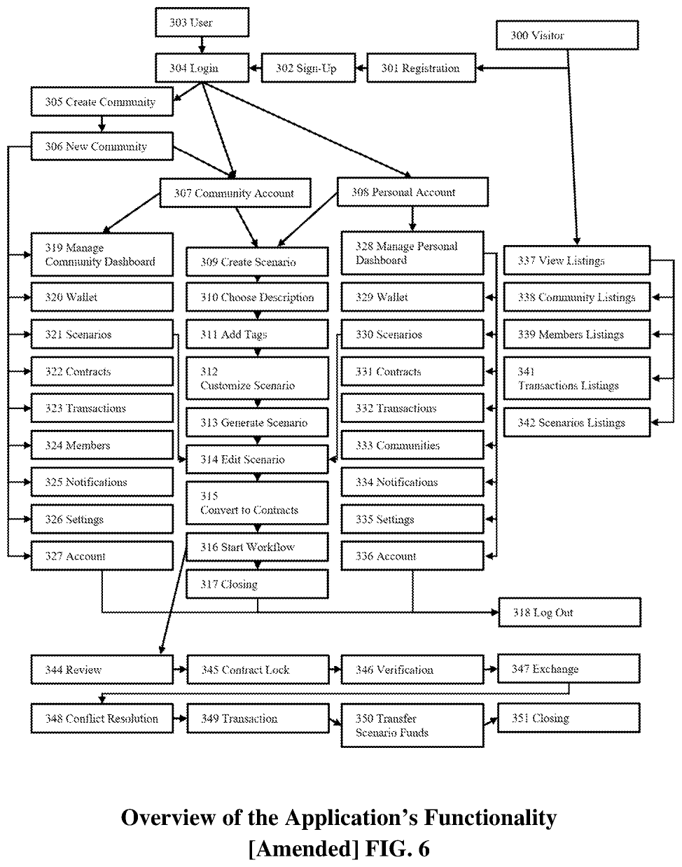

Referring to FIG. 3 and FIG. 4, in one embodiment 220 that represents scenario_u0 a scenario created by user 0, similarly 221 that represents scenario_u1 a scenario created by user 1, 222 that represents scenario_u2 a scenario created by user 2, 223 that represents scenario_u3 a scenario created by user 3, 224 that represents scenario_u4 a scenario created by user 4, 225 that represents scenario_u5 a scenario created by user 5. In horizontal scaling of scenarios user 0 attaches other users' scenarios: scenario_u1, scenario_u2, scenario_u3, scenario_u4, scenario_u5, scenario_u6 to users own scenario_u0 in horizontal fashion as shown in FIG. 3. Similarly, in vertical scaling, each user attaches one other scenario at a time. For example, user 0 who created scenario_u0 will attach scenario_u1, similarly user 1 who created scenario_u2 will attach scenario_u3. whereas 200 is representation of various steps involved in the creation of everyday human transactions with the help of computer systems and network block nodes which is explained in detail later on.

Those of skill in the art will appreciate that the contracts echo system 108 may contain other modules that are not described herein. In addition, conventional elements, such as firewalls, authentication systems, payment processing systems, network management tools, load balancers, and so forth are not shown as they are not material to the invention. The system 108 may be implemented using a single computer, or a network of computers, including cloud-based computer implementations. The computers are preferably server class computers including one or more high-performance CPUs and 1G or more of main memory, and running an operating system such as LINUX or variants thereof The operations of the system 108 as described herein can be controlled through either hardware or through computer programs installed in non-transitory computer storage and executed by the processors to perform the functions described herein. The various stores (e.g., communities store 241, a members store 242, a transactions store 243) are implemented using non-transitory computer-readable storage devices, and suitable database management systems for data access and retrieval. The system shown in FIG. 1 may include other hardware elements necessary for the operations described here, including network interfaces and protocols, input devices for data entry, and output devices for display, printing, or other presentations of data.

### Data Stores and Objects Declarations

The communities store 241 persistently stores data describing communities in the contracts echo system 108. Each community is represented by a community object. Information about a community may include community name, community description, community location, community members, community members count, market volume, transactions, contracts, scenarios, and the like.

The members store 242 persistently stores data describing users in the contracts echo system 108. Each user is represented by a member object, which may also be called a user profile. Information about users includes user personal information such as name, user name, email address, location, phone number, preferences, transactions, contracts, scenarios, communities joined, and the like.

The transactions store 243 persistently stores data describing transactions in the contracts echo system 108. Each transaction is represented by a transaction object. Information about the transactions includes transaction id, description, buyer gcuid, seller gcuid, price tag/downgain, time stamp, attachments, attachments count, related tags, and the like.

The scenarios store 244 persistently stores data describing scenarios in the contracts echo system 108. Each scenario is represented by a scenario object. Information about the scenarios includes scenario id, description, creator gcuid, contracts created count, transactions created count, last updated, upgain, downgain, netgain, downgain attachments, and the like.

The contracts store 245 persistently stores data describing contracts in the contracts echo system 108. Each contract is represented by a contract object. Information about the contracts includes contract reference id, description, buyer gcuid, seller gcuid, downgain/price tag verification gcuid resolution gcuid, workflow status 1 workflow status 2, workflow status 3, workflow status 4, workflow status 5, workflow status 6, workflow status 7, workflow status 8, and the like.

The listing store 246 persistently stores data describing contract echo systems' listings (e.g., communities, members, transactions, scenarios) in the contracts echo system 108. Each listing is represented by a listing object. Information about listing may include respective items, objects, and the like.

The workflow store 247 persistently stores data describing workflow in the contracts echo system 108. Each workflow is represented by a workflow object. Information about the workflow includes workflow revision, workflow contract lock, workflow verification, workflow exchange, workflow conflict, workflow off-chain transaction, workflow on-chain transaction, workflow closing, and the like.

The dashboard store 248 persistently stores data describing personal or community dashboard in the contracts echo system 108. Each dashboard is represented by a dashboard object. Information about the dashboard includes information relating to the user's wallet, stacking, contracts, transactions, communities, settings, account information, and the like.

The description stores 249 persistently stores data describing scenario descriptions in the contracts echo system 108. Each description is represented by a description object. Information about the description may include scenario_description_pre (e.g I want to ______),
scenario_description_verb (e.g build ______),
scenario_description_first_line (e.g tesla ______),
scenario_description_second_line (e.g modal S ______), and the like.

The configuration store 250 persistently stores data configuration and system settings in the contracts echo system 108.

### Modules Functionality

The community's module 251 is a set of computer instructions stored on a web server for managing community functionalities by interacting with users on user devices 104.

The members module 253 is a set of computer instructions stored on a web server for managing members' functionalities by interacting with users on user devices 104.

The transactions module 256 is a set of computer instructions stored on a web server for managing transaction functionalities by interacting with users on user devices 104.

The scenarios module 259 is a set of computer instructions stored on a web server for managing scenario functionalities by interacting with users on user devices 104.

The contracts module 263 is a set of computer instructions stored on a web server for managing contract functionalities by interacting with users on user devices 104.

The search module 266 is a set of computer instructions stored on a web server for managing search functionalities by interacting with users on user devices 104.

The workflow module 267 is a set of computer instructions stored on a web server for managing workflow functionalities by interacting with users on user devices 104.

The dashboard module 269 is a set of computer instructions stored on a web server for managing dashboard functionalities by interacting with users on user devices 104.

The description module 272 is a set of computer instructions stored on a web server for managing description functionalities by interacting with users on user devices 104.

The configuration module 275 is a set of computer instructions stored on a web server for managing configuration functionalities by interacting with users on user devices 104.

### Functionality Overview

The process can be understood by looking at FIG. 6 which describes the process flow of the proposed system. The individual accessing the website can be a visitor 300 or a user 303. If the process is initiated by a visitor 300, he/she can view listings 337. The listings include multiple options including but not limited to Communities Listings 338, Members Listings 339, Transactions Listings 341, and Scenarios Listings 342. The visitor will also be presented with a display screen that provides Registration module 301. By providing the requested information, the visitor 300, can complete the signup 302 process and can reach the Login 304 screen. A user 300 will also be presented with a Login 304 screen and will lead to various options once the Login 304 process is completed successfully.

The process further leads the user 300 to multiple options which include Community Account 307 and Personal Account 308 based on user configuration store 250. The Community Account 307 and Personal Account 308 will allow user 303 to Create Scenario 309, which will allow users to Choose Description 310. The user can Add Tags 311, customize Scenario 313, Generate Scenario 313, or Edit Scenario 314 that also includes various sub-steps as shown in FIG. 7 and FIG. 8, such as setting terms between the user who attached the scenario and the user whose scenario was attached. Once a Scenario is customized successfully, the user can press the option of Convert to contracts 315, which will lead to Start Workflow 316. The process is completed with a Closing screen 317. The user 303 can close the session anytime by pressing the Logout 318 option.

The user 303 from Community Account 307 can also utilize the option of Mange Community Dashboard 319. This allows the user 303 to access Wallet 320, Scenarios 321, Contracts 322, Transactions 323, Members 324, Notifications 325, Settings 326, and Account 327. The user 303 can close the session anytime by pressing the Logout 318 option.

The user 303 can also access their Personal Account 308 and can Manage Personal Dashboard. This allows the user 303 to access personalized Wallet 329, Scenario 330, Contracts 331, Transactions 332, Communities 323, Notifications 334, Settings 335, and Account 336. The user 303 can close the session anytime by pressing the Logout 318 option.

On the backend, once the contract is converted 315 and workflow is started 316, the system will review 344 with its proprietary algorithms and the contract will be locked 345. The verification 346, exchange 347, and conflict resolution 348 processes will be initiated respectively for smooth tarnation 349. The process will involve Transfer of Scenario Funds 350 and will close 351 the process successfully.

Use Case with Horizontal Scaling

FIG. 7 explains the horizontal scaling process. The horizontal scaling process can include multiple users having their own scenarios linked with one main Scenario. For instance, the User 0 360, has Scenario 0 referred by 361 here. User 1 has Scenario A referred as 365, User 2 367 has Scenario B referred as 368, User 3 370 has Scenario C referred as 371, User 4 373 has Scenario D referred as 374, User 5 376 has Scenario E referred as 377, User 6 379 has Scenario F referred as 380 which all refer to various types of scenarios and are linked with one main Scenario. For instance, the Scenario 0 361 is “I can manufacture electric vehicle 362 is the main Scenario over here. Scenario A 365 is “I can supply metal oxide for EV batteries 366. Scenario B 368 which is attached to the main scenario is “I can invest in EV batteries manufacturing” 369. Scenario C 371 is “We will verify the delivery of shipment” 372. Scenario D 374 is “I will resolve conflict for Scenario in manufacturing industry” 375. Scenario E 377 is “We are raising funds for community expenditures” 378. Scenario F 380 is “I can donate for EV batteries manufacturing” 381. All of these Users will be interacting with each other based on their Scenarios.

All of these Scenarios are hatched to Scenario 0, which is created by User 0. This will require each member to define Cost Terms 382 which are variable as per each Scenario. This process will further involve Verification Terms 383 and resolution terms 384 which will keep in the loop until mutual agreement is achieved between both parties having one main Scenario and one secondary Scenario. In the case of donations, as mentioned in Scenario 381, the donation amount terms 386 will be set by User 6 279.

Scenario 0 361 will form a contract with other Scenarios and then the transaction will be executed. For instance, Scenario 0 361, will lock Contract 390 with Scenario A 365, and Transaction 392 will be executed. Scenario 0 361, will lock Contract 390 with Scenario B 368, and Transaction 392 will be executed. Scenario 0 361, will lock Contract 390 with Scenario C 371 and Transaction 392 will be executed. Scenario 0 361, will lock Contract 390 with Scenario D 374, and Transaction 392 will be executed. Scenario 0 361, will lock Contract 390 with Scenario E 377, and Transaction 392 will be executed. Scenario 0 361, will lock Contract 390 with Scenario F 380, and Transaction 392 will be executed.

Use Case with Vertical Scaling

FIG. 8 details the process of Vertical Scaling which is mainly between two users and involves selling of one main idea among multiple users. User 0 360, has Scenario 0 referred by 361. The User 1 364 has Scenario A referred as 365, User 2 367 has Scenario B preferred as 368, User 3 370 has Scenario C referred as 371, User 4 373 has Scenario D referred as 374, User 5 376 has Scenario E referred as 377, User 6 379 has Scenario F referred as 380 which all refer to various types of scenarios. All the contract formations including the setting of Cost Terns 382, Verification terms 383, and Resolution Terns 384 will be identified between the two parties. Thus, in vertical scaling, there is no one main contract unlike horizontal scaling, and will involve multiple activities of Contract setting and transactions.

### Scenario Funds Transfer

FIG. 9 describes in detail the Funds transfer module which includes mainly two users herein referred to as User 0 360 and User 1 364. User 0 360 having main Scenario 0 will initiate the Transaction 393 module and User 1 364 will also be part of the process with Scenario A 365. Scenario 0 funds 415 will include Downgain 416 and will change to Upgain 417 and funds will be transferred to Scenario A Funds 418.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, the inventive subject matter lies in less than all features of a single disclosed embodiment. Thus, the following claims are hereby incorporated into the Detailed Description, with each claim standing on its own as a separately claimed subject matter.

claim:

1. A computer-implemented method for creating scenario-based business transactions, comprising:
receiving, by a processor and from a first user of a contracts echo system, a first plurality of information relating to a primary scenario, wherein the first plurality of information includes a scenario description and one or more scenario tags;
based on the obtained first plurality of information, generating, by the processor, the primary scenario, the primary scenario being accessible to users of the contracts echo system;
receiving, by the processor and from one or more non-first users, a second plurality of information relating to one or more auxiliary scenarios, wherein the second plurality of information includes one or more cost terms, one or more verification terms, and one or more resolution terms;
based on the obtained second plurality of information, generating, by the processor, the one or more auxiliary scenarios, the one or more auxiliary scenarios being accessible to users of the contracts echo system;
linking, by the processor, the one or more auxiliary scenarios to the primary scenario;
receiving, by the processor and from the first user, a request to convert the linked scenarios to one or more contracts; and
in response to receiving the request from the first user, generating, by the processor and based on the first plurality of information and the second plurality of information, a contract for each linked auxiliary scenario, the one or more generated contracts each comprising the cost terms, the verification terms, the resolution terms, and one or more parties to the contract, the one or more generated contracts being accessible to users of the contracts echo system.

2. The method of claim 1, further comprising:
for each of the one or more generated contracts:
receiving, by the processor, an acceptance of the contract from each contracting party;
in response to receiving an acceptance of the contract from each contracting party, locking, by the processor, the contract;
verifying, by the processor, the validity of the contract;
receiving, by the processor, a confirmation that an exchange of a plurality of goods and services has occurred from each contracting party;
in response to receiving the one or more confirmations that an exchange of a plurality of goods and services has occurred, resolving, by the processor, one or more potential conflicts based on the one or more of the contract's conflict resolution terms; and
transferring, by the processor, scenario funds based on the one or more cost terms.

3. The method of claim 2 further comprising:
storing, by the processor, a third plurality of information relating to the executed scenarios and contracts on the internet and/or blockchain.

4. The method of claim 3, wherein the linking process comprises:
linking, by the processor, each of the one or more auxiliary scenarios to the primary scenario, such that the primary scenario is linked to each and every auxiliary scenario and the one or more auxiliary scenarios are each linked only to the primary scenario.

5. The method of claim 3, wherein the linking process comprises:
linking, by the processor, the auxiliary scenario first-in-time to the primary scenario; and
linking, by the processor, a new auxiliary scenario to the most recently linked auxiliary scenario.

6. A non-transitory computer readable storage medium that stores instructions that, when executed by a processor, cause the processor to perform a method comprising:
receiving, from a first user of a contracts echo system, a first plurality of information relating to a primary scenario, wherein the first plurality of information includes a scenario description and one or more scenario tags;
based on the obtained first plurality of information, generating the primary scenario, the primary scenario being accessible to users of the contracts echo system;
receiving, from one or more non-first users, a second plurality of information relating to one or more auxiliary scenarios, wherein the second plurality of information includes one or more cost terms, one or more verification terms, and one or more resolution terms;
based on the obtained second plurality of information, generating the one or more auxiliary scenarios, the one or more auxiliary scenarios being accessible to users of the contracts echo system;
linking the one or more auxiliary scenarios to the primary scenario;
receiving, from the first user, a request to convert the linked scenarios to one or more contracts; and
in response to receiving the request from the first user, generating, based on the first plurality of information and the second plurality of information, a contract for each linked auxiliary scenario, the one or more generated contracts each comprising the cost terms, the verification terms, the resolution terms, and one or more parties to the contract, the one or more generated contracts being accessible to users of the contracts echo system.

7. The non-transitory computer readable storage medium of claim 6 that further stores instructions that, when executed by a processor, cause the processor to further perform a method comprising:
for each of the one or more generated contracts:
receiving an acceptance of the contract from each contracting party;
locking the contract in response to receiving an acceptance of the contract from each contracting party;
verifying the validity of the contract;
receiving a confirmation that an exchange of a plurality of goods and services has occurred from each contracting party;
in response to receiving the one or more confirmations that an exchange of a plurality of goods and services has occurred, resolving one or more potential conflicts based on the one or more of the contract's conflict resolution terms; and
transferring scenario funds based on the one or more cost terms.

8. The non-transitory computer readable storage medium of claim 7 that further stores instructions that, when executed by a processor, cause the processor to further perform a method comprising:
storing, by the processor, a third plurality of information relating to the executed scenarios and contracts on the internet and/or blockchain.

9. The non-transitory computer readable storage medium of claim 8, wherein the linking process comprises:
linking, by the processor, each of the one or more auxiliary scenarios to the primary scenario, such that the primary scenario is linked to each and every auxiliary scenario and the one or more auxiliary scenarios are each linked only to the primary scenario.

10. The non-transitory computer readable storage medium of claim 8, wherein the linking process comprises:
linking, by the processor, the auxiliary scenario first-in-time to the primary scenario; and
linking, by the processor, a new auxiliary scenario to the latest linked auxiliary scenario;

11. A system comprising one or more processors and one or more non-transitory computer-readable memories coupled to the one or more processors and configured with instructions executable by the one or more processors to cause the system to perform operations comprising:
receiving, by a processor and from a first user of a contracts echo system, a first plurality of information relating to a primary scenario, wherein the first plurality of information includes a scenario description and one or more scenario tags;
based on the obtained first plurality of information, generating, by the processor, the primary scenario, the primary scenario being accessible to users of the contracts echo system;
receiving, by the processor and from one or more non-first users, a second plurality of information relating to one or more auxiliary scenarios, wherein the second plurality of information includes one or more cost terms, one or more verification terms, and one or more resolution terms;
based on the obtained second plurality of information, generating, by the processor, the one or more auxiliary scenarios, the one or more auxiliary scenarios being accessible to users of the contracts echo system;
linking, by the processor, the one or more auxiliary scenarios to the primary scenario;
receiving, by the processor and from the first user, a request to convert the linked scenarios to one or more contracts;
in response to receiving the request from the first user, generating, by the processor and based on the first plurality of information and the second plurality of information, a contract for each linked auxiliary scenario, the one or more generated contracts each comprising the cost terms, the verification terms, the resolution terms, and one or more parties to the contract, the one or more generated contracts being accessible to users of the contracts echo system.
for each of the one or more generated contracts:
receiving, by the processor, an acceptance of the contract from each contracting party;
in response to receiving an acceptance of the contract from each contracting party, locking, by the processor, the contract;
verifying, by the processor, the validity of the contract;
receiving, by the processor, a confirmation that an exchange of a plurality of goods and services has occurred from each contracting party;
in response to receiving the one or more confirmations that an exchange of a plurality of goods and services has occurred, resolving, by the processor, one or more potential conflicts based on the one or more of the contract's conflict resolution terms;
transferring, by the processor, scenario funds based on the one or more cost terms; and
storing, by the processor, a third plurality of information relating to the executed scenarios and contracts on the internet and/or blockchain.

12. The system of claim 11, wherein the linking process comprises:
linking, by the processor, each of the one or more auxiliary scenarios to the primary scenario, such that the primary scenario is linked to each and every auxiliary scenario and the one or more auxiliary scenarios are each linked only to the primary scenario.

13. The system of claim 11, wherein the linking process comprises:
linking, by the processor, the auxiliary scenario first-in-time to the primary scenario; and
linking, by the processor, a new auxiliary scenario to the latest linked auxiliary scenario.
